(19) United States
(12) Patent Application Publication
(10) Pub. No.: US 2014/0340770 A1
(43) Pub. Date: Nov. 20, 2014

(54) Lens assembly for the motor vehicle; a driver's aid for enhaned visibility while driving

(71) Applicants: Thomas John Barniak, JR., Medina, OH (US); Steve S. Nichy, Medina, OH (US)

(72) Inventors: Thomas John Barniak, JR., Medina, OH (US); Steve S. Nichy, Medina, OH (US)

(21) Appl. No.: 13/986,567

(22) Filed: May 15, 2013

(51) Int. Cl. G02B 25/00

(52) U.S. Cl. CPC G02B 25/002
USPC 359/802

(57) ABSTRACT

An assembly for the driver of a motor vehicle to mount onto the desired structure in the driver cockpit area such as the overhead sun visor or rearview mirror. The assembly consists of a transparent lens or multiple lenses contained in a holding structure with attachment means for the specified structure meant to be attached there onto. The lens or lenses are designed of a prescription for that driver so as to enhance visually in a clarifying manner a long distant highway object such as an overhead road sign mounted on an overpass or a traffic signal to state just two examples eligible and important for visual enhancement in everyday highway driving. Prescriptions for the lens or lenses will be as various as the driving public is both near and far sighted to certain degrees thereof.

### CROSS-REFERENCE TO RELATED APPLICATIONS

This application claims the benefit of provisional patent application Ser. No. 61/688,613, filed 2012 May 18 by the present inventors, which is incorporated herein.

### BACKGROUND OF THE INVENTION

1. Field of the Invention

The present invention relates to the driving of any motor vehicle on any road, highway, or interstate highway by any driver and especially pertains unto that driver's ability to see and comprehend road signs and traffic signals in everyday driving. Bad weather, poor atmospheric conditions, long distances and less than 20/20 vision are some of the problematic factors that confront the everyday driver relating to that driver's ability to read and comprehend road signs and traffic signals sometimes. A driver's reaction time after seeing a directional road sign or traffic signal can be critical in certain driving scenarios. The time that it takes for a driver to make a lane change after comprehending the information on the road sign can be compromised if that driver cannot, for one of the factors aforementioned, make that lane change in time, for example, to exit or turn from the highway. Allowing the everyday driver a means to enhance that driver's ability to read and comprehend all signs and signals on a highway would be of great benefit pertaining to reaction time for that driver and thereby allowing for a safer and more effective driving experience for all drivers on the highway.

2. Description of the Related Art

After a thorough search of the marketplace and USPTO patent database, the present inventors have concluded that there is no prior art relating unto the present invention that is disclosed herein. The present inventors did find that the problem of road sign recognition is being addressed in patent applications in an electronic manner, but that method is non-relating unto the present invention which is forwardly disclosed.

### SUMMARY OF THE INVENTION

The present invention is a motor vehicle driver's aid that improves that driver's visibility range for initially seeing and recognizing road signs and/or traffic-directional signs or signals in that driver's particular visibility field in front of the windshield of the motor vehicle being driven, thereby allowing for a faster reaction time relating to the information on the road sign or signal by that driver. More precisely stating, the present invention is an assembly comprised of a single lens or a multiple series of lenses contained in a holding structure, the holding structure therein disposed at a visibility point on the inside of the front windshield conducive for the driver to view an object through the lens or lenses. The lens or lenses can be of a specifically ground prescription type or a combination thereof of existing lens types suitable for an inline or adjacent type of disposition in a holding structure. Ideally, the lens or multiple lenses should slightly magnify the subject object viewed through the lens or lens series, but the inventors have determined that a clarification or sharpening factor incorporated into the long-distance range capability of that lens or lens series is just as foremost in determining enhancement of a distant object, such as an overhead road sign hung on a highway overpass just beyond a driver's visibility range of comprehension. More exactly stating, grind a lens so that it actually gives a viewer better than 20/20 vision. This exact scenario has been disclosed and discussed with independent eyeglass lens laboratories by the present inventors. A more precise statement relating unto the feasibility of this new prescription grinding of lenses forthcoming in this specification. The lens or lenses are suitable as glass or plastic composition. The lens holding structure is suitable for plastic composition.

Pertaining to disposition of the aforementioned lens or multiple lenses at a desired point on a motor vehicle windshield on its interior driver's seat side, the driver's side overhead hinged sun visor, a factory-installed implement on all motor vehicles, is a perfect structure for mounting the holding structure containing the lens or lenses. To accomplish this feat, the holding structure simply has to incorporate means to attach to the bottom edge side of the visor. Since the lens holding structure is perfectly suitable for plastic composition construction, it will simply be a matter of forming an attaching means at points on the holding structure deemed as the strategically functional points of contact with the desired implement.

Another advantageous disposition area of the motor vehicle windshield for the lens holding structure to be disposed at would be the area directly at circumstantial points about the rear view mirror mounted unto the interior surface of the windshield. Since the rear view mirror is mounted at a high point on the interior windshield surface at its center point on all motor vehicles, its also a perfect structure for affixing or attaching unto by the lens holding structure. A means of attaching to the rear view mirror, whether by a clip, gripping jaws, friction type slide-on implement structure or various other means will simply have to be incorporated at a functional and desirable point or points on the lens holding structure. A rear view mirror disposition of the lens holding structure allows the driver of that motor vehicle to glance through the lens or lenses at a road or street sign located at his or her extreme right direction. This could be very important, visually wise, when travelling in multiple lanes of traffic, some of which can exceed 8 lanes in one direction. The lens enhancement of the traffic signal or sign will give that driver more reaction time if that driver is looking to move and merge to the right in heavy motor vehicle traffic to engage with an exit ramp from that particular highway.

While under Provisional Patent pending status, the present inventors have discussed the feasibility factor of developing the lens or lenses with eyeglass laboratory professionals in the eye vision health industry. The professionals contacted and even physically met with by the present inventors concluded, after a thorough explanation of what exact function the inventors were seeking in a lens or multiple lens arrangement for a driver of a motor vehicle, that a lens or lenses could be created for both the near and far-sighted public with some research and development. Unfortunately, these same professionals cut off all contact with the present inventors after they disclosed their invention totally as the present inventors had no choice but to do to get an enabling feasability established pertaining to the lens or lenses part of the present invention. While disappointed at their so-called professionalism, the present inventors came away with the fact that a lens or even current lenses available presently have the possibility of giving a said driver a new type of high-definition or enhancement capability of a distant object, such as a road sign, just beyond that driver's current long-distance vision range. This fact can be better explained by the present inventor writing this specification in the following emphasizing paraphrase; all drivers of motor vehicles, whether with corrected vision with eyeglass lenses in either a near or far-sighted prescription fashion, or uncorrected, with a vision range measuring 20/20 to 20/40 behind the driving wheel—both drivers have their long-distance limit to their vision, whereas an object such as a highway road sign is unreadable or just out of range of comprehension to that driver. A lens or series of more than one lens held in a holding structure disposed in a perpendicular fashion in relation unto that driver's eye direction sight line—straight ahead and in a range of six inches to eighteen inches or thereabouts as in the case of the holding structure mounted unto the driver's overhead sun visor and/or the windshield mounted rearview mirror—can enhance that driver's ability to see clearer a distant object presently just beyond that driver's range of comprehension. An example of how to achieve this feat as follows; the present inventors point to a current eyeglass type of lens called a reading lens for close-up usage and made to be worn by the user. If one holds a typical weak +1.25 reading lens at a range from their eyes about one to two feet away and looks at a distant object they will note some slight to moderate magnification quality to the lens in relation to the object observed through the lens but with a slight blurring also. The +1.25 lens prescription can be changed by grinding the lens so it maintains the slight magnifying trait aforementioned and eliminating the blurring. The magnifying trait coupled with clarification provides a viewer through that new prescription lens with a new type of high-definition range of vision at long distances. A range of new prescriptions for both the near and farsighted as well as the uncorrected 20/20 prescribed driver is possible from common reading lenses of different dioptrical powers. The lens component entity of the present invention will not be of a one-size-fits-all type but of a selection of different prescriptions that enhance that particular driver's long-distance vision. The driver will simply have to look through the prescribed lens to see if it magnifies and/or clarifies objects superior to the driver's current long distance vision. The aforementioned range of new prescriptions forthcoming designed for the lens component of the present invention refers back to what the present inventor referred to as some needed research and development by an eyeglass lens laboratory but most assuredly can be accomplished.

Pertaining to the feasibility of multiple lenses placed in an adjacent fashion in a holding structure as the lens component of the present invention, the present inventors disclosed their invention to a local optometrist for feasibility of the lens or lenses component of the present invention and for a partnering possibility of marketing the present invention. The optometrist, who's interest in a lens possibility was very evident to the present inventor who disclosed the present invention to the doctor, repeatedly told the present inventor it wasn't possible to achieve because of various reasons, which were aforementioned in this specification such as the driver population either as a plus or minus—near or far-sighted factor type relating to lenses. But then at another meeting with the doctor, the doctor flatly told the present inventor who is writing this specification that he had achieved a high-definition or greater than 20/20 vision state with multiple lenses placed in a front-to-back or adjacent scenario—exactly what the present inventor had disclosed to the doctor he was seeking for the present invention. Unfortunately, this doctor also informed the present inventor he was going to develop and market the lens arrangement by himself, and at that point, got up and dismissed the present inventor and said no more words relating to the present invention. Again, both present inventors are shocked at the lack of professionalism by these so-called professionals, but the situation is what it is.

The present inventor writing this specification whom actually disclosed the present invention to the aforementioned eyeglass laboratory tech people and doctor in the previous paragraph and therein was shunned and dismissed is disclosing these facts in this specification for an important reason; the present inventor's experience gives credence to the enabling factor that is required in a patent application—the present inventor already knows an achievement of a multiple lens arrangement for viewing through by a driver providing high definition enhancement for road sign recognition at long distance is positive pertaining unto its feasability and that a single or mono lens allowing for an enhancement factor for both the near and farsighted driver is very possible with some research and development put towards that solution. This fact was confirmed to the present inventor by the aforementioned eyeglass lens tech people at three different eyeglass lens manufacturing laboratories who therein cut off all contact with the present inventor after disclosure of the present invention.

A positive understanding of the present invention will be realized after analysis of the following drawing views and the detailed description and operation of the best embodiment models. A modification to the present invention by anyone other than the present inventors shall not construe a deviation from the present invention's scope and intention.

### DRAWINGS

FIG. 1 is a perspective view of a lens holding structure containing a lens mounted or attached to the bottom end side of the driver's side overhead sun visor in a typical motor vehicle.

FIG. 2 is a close-in view of the lens holding structure mounted to the bottom end side of the driver's overhead sun visor of FIG. 1 showing an enhanced road sign in the distance as would be viewed by the driver. Note the visor in an up position.

FIG. 3 is a close-in view of a lens holding structure mounted to the sun visor with the visor in the down position. All overhead sun visors have this capacity of this adjustment for their function as relating to shielding or blocking the sun if needed as such by the driver.

FIG. 4 is a close-up view of a lens holding structure containing a lens and also showing means to attach to an overhead sun visor and in this view shown as a jaw type of gripping means.

FIG. 5 is a cross sectional side view of the lens holding structure of FIG. 4.

FIG. 6 is a side view of a holding structure containing two lenses with jaw type gripping means of attachment.

FIG. 7 is a perspective view of a typical motor vehicle driver's cockpit area showing a lens holding structure mounted or attached to that motor vehicle's rear view mirror. A road sign is viewed through the lens.

FIG. 8 is a cross sectional side view of the lens holding structure of FIG. 7 showing the holding structure frame, a ball and socket adjustment type joint and a wider slide-on gripping type of attaching means unto the wider body of the rear view mirror holding structure.

FIG. 9 is a perspective view of another embodiment type of the total assembly present invention showing a lens holding structure frame containing a lens, a slidable ball and socket joint mounted on a horizontal bar and a suction cup type means of attachment.

FIG. 10 is a perspective view of a lens holding structure containing a lens that could be hand held as well as being mounted with means of attachment.

DRAWINGS- Reference Numerals

| | |
|---|---|
| 11 | lens holding structure frame- plastic composition |
| 12 | lens and/or lenses- plastic composition or glass |
| 13 | means of attachment- friction jaw type-hinged |
| 14 | ball and socket joint |
| 15 | means of attachment- slide on gripping type |
| 16 | horizontal bar |
| 17 | slidable body section- rear of ball and socket joint |
| 18 | means of attachment- suction cup type |
| 19 | tangential arm segment on lens frame |

### DETAILED DESCRIPTION AND OPERATION OF DRAWING FIGURES

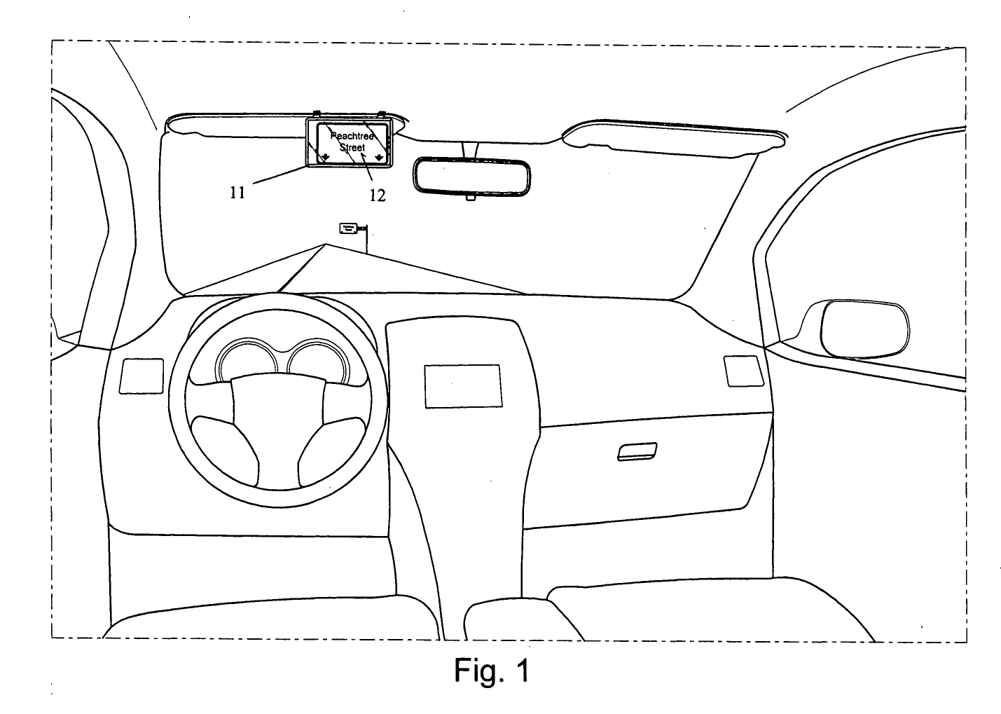

FIG. 1 is a broad perspective view of the total present invention assembly mounted or attached in a friction type fashion unto the driver's side overhead sun visor. The overhead visor is shown in its up position and not deployed by the driver as the sun shield its designed to function as. The lens holding frame 11 containing a lens or lenses 12 shows a distant road sign in an enhanced state for viewing by the driver. The driver simply has to take a quick glance at the lens from the driver's sitting position as the road sign image passes in front and therein through the lens or lenses 12 contained in the holding frame 11. The driver will take less time to read and comprehend the distant road sign now in an enhanced state and will be able to get his or her eyes back to focusing on the highway being traveled at a quicker time—less time being spent at trying to focus on the distant road sign, exactly stating.

FIG. 2 is a close-in view of the total present invention assembly shown in FIG. 1 showing the lens holding structure frame 11 with lens or lenses 12 contained within mounted or attached to the driver's side overhead sun visor with friction type jaws 13 for gripping the bottom end side of the visor. The jaws can be spring loaded or otherwise and contains a slidable friction type hinge for vertical adjustment to a perpendicular state for viewing through the lens or lenses 12 by the driver.

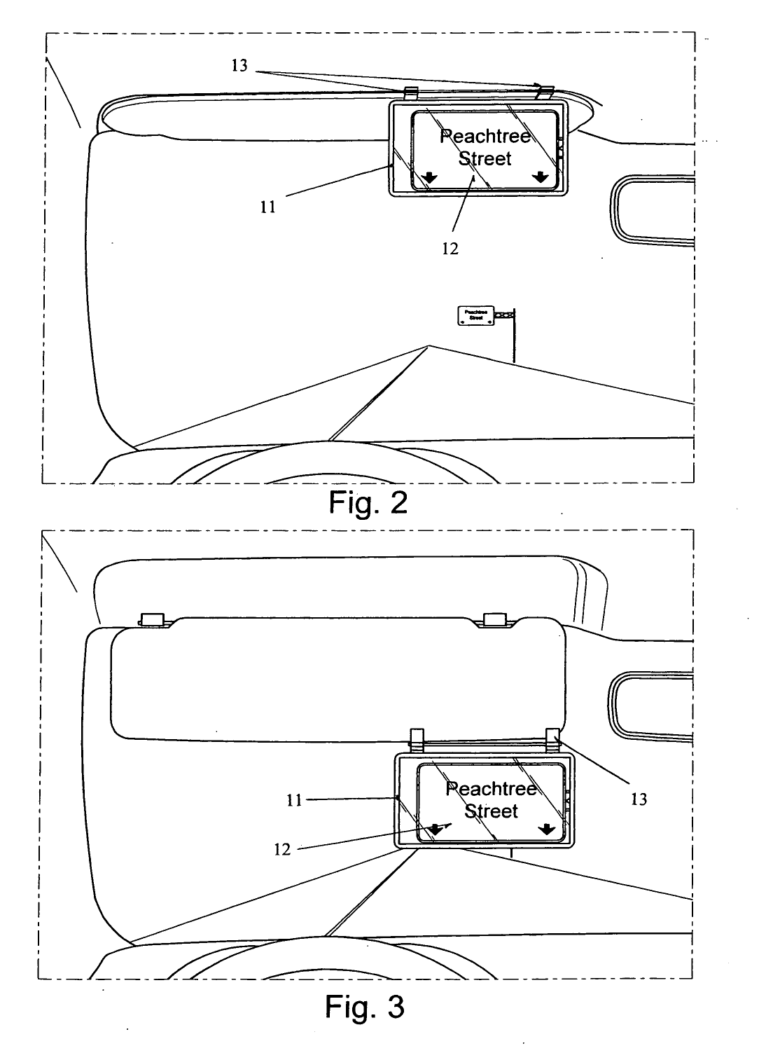

FIG. 3 is a close-in view of the total present invention assembly attached to the overhead sun visor in its deployed or down position. The overhead sun visor, since it is also hinged for up or down deployment, allows adjustment in height for the total present invention assembly. The driver simply has to adjust the lens holding frame 11 to a vertical or perpendicular state relative to the driver's eye line of vision through the windshield. The hinged jaws 13 provide a simple and fast adjustment to a vertical state. The overhead sun visor, in either an up or down state of deployment, can be used by the driver to view distant road signs through the lens holding frame 11. The two hinges shown in both FIG. 2 and 3 share a common hinge bar capable of revolving 360 degrees or thereabouts for the aforementioned vertical adjustment and alignment for the driver.

FIG. 4 is a perspective view of the lens holding frame 11 containing a lens or lenses 12 and two friction jaw type hinged means of attachment. The hinged jaws 13 contain their own self-contained bar for slidably revolving about an axis therein allowing for the said vertical alignment for driver. This view is for showing versatility in construction of the total invention is possible and probable.

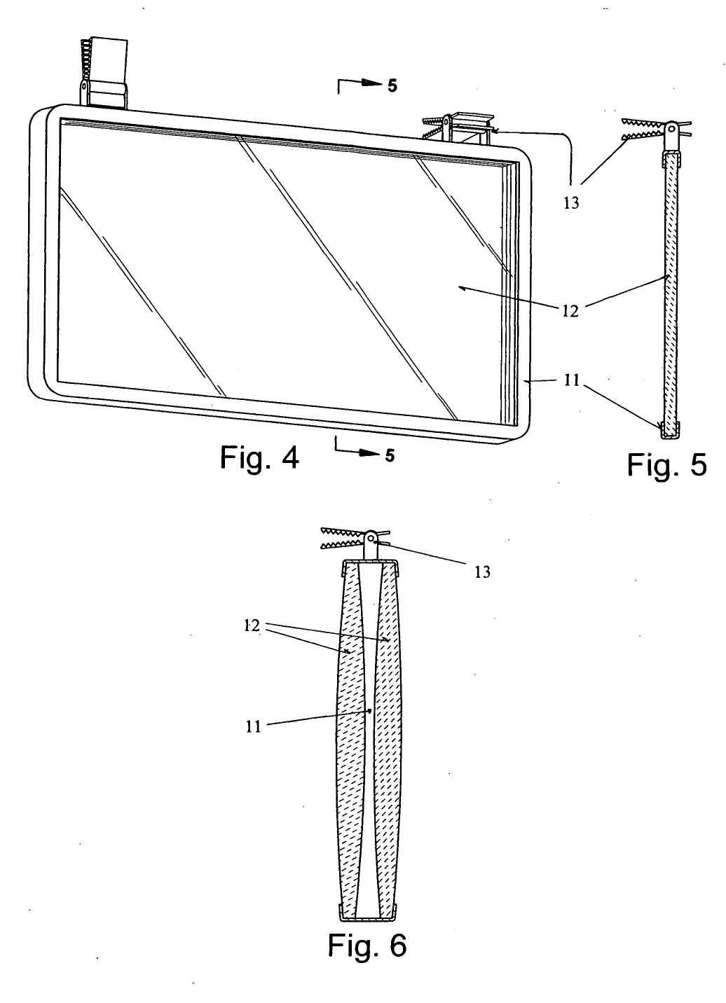

FIG. 5 is a side sectional perspective view of FIG. 4 showing how a single lens 12 might look contained in its holding frame 11 and also showing one of two hinged jaws 13.

FIG. 6 is a side sectional view showing how multiple lenses, in this view as two in number, might look contained in its holding frame 11. Both FIGS. 5 and 6 are shown as examples of possible types of construction pertaining unto the holding structure frame 11. Many types of holding frame designs are possible and probable.

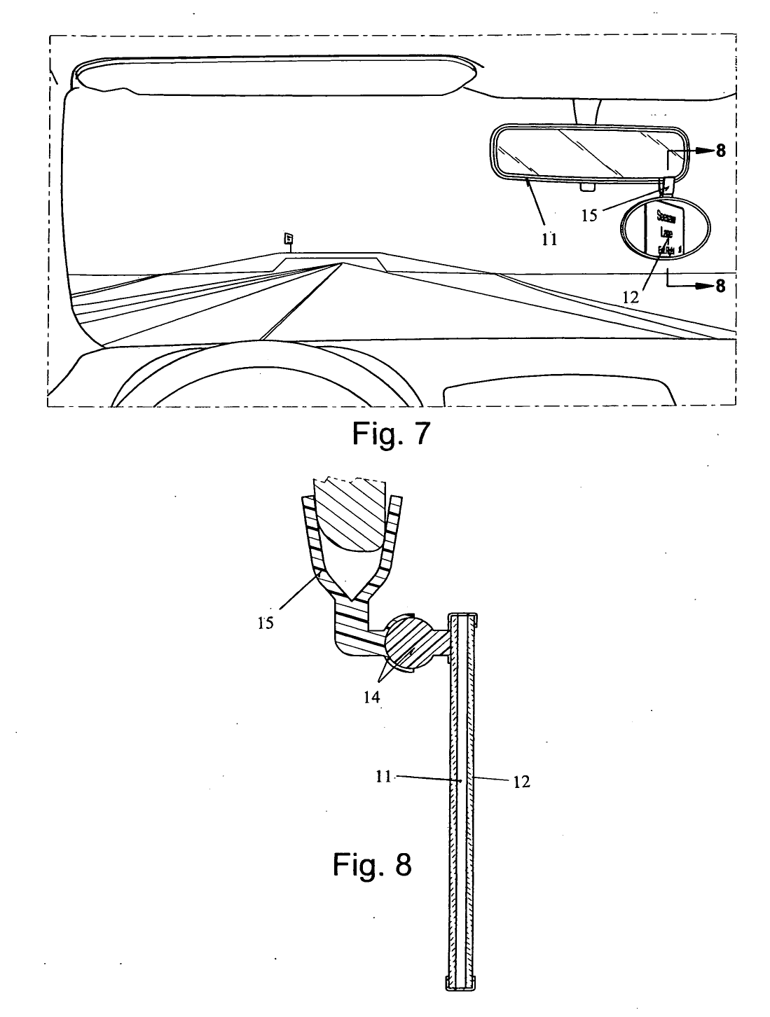

FIG. 7 is a perspective view of a motor vehicle driver's side cockpit area showing how the total invention assembly including the lens or lenses 12 contained in holding frame 11 with means of attachment 15 attached unto the right bottom end side of the motor vehicle rearview mirror. This deployment of the said total invention assembly allows the driver to view distant road signs, signals or street signs at the driver's right side perspective as the rearview mirror is mounted to the driver's right. The view shows an oval shaped lens for a versatility factor pertaining to construction. A quick view or glance from the driver to his or her right, through the holding frame 11, as the highway implement passes in front of the lens or lenses 12 will simply be all it takes for the enhanced view of that particular object to be comprehended by the driver.

FIG. 8 is a side perspective sectional view of the total invention assembly of FIG. 7. The view shows a possible construction type of the total invention assembly which is designed to slidably mount unto the vehicle's rearview mirror body frame with a gripping type means of attachment 15 utilizing wider jaws to compensate for a typical rearview mirror frame body. Also, a ball and socket swivel joint 14 would be utilized in this deployment of the total assembly invention so as to give the driver ability to adjust the lens or lenses holding frame 11 in a horizontal and vertical fashion for the proper perpendicular viewing plane for that driver, much as the rearview mirror itself contains a ball and socket arrangement built into its attachment frame armature stemming from the interior windshield face for the same type of adjustment.

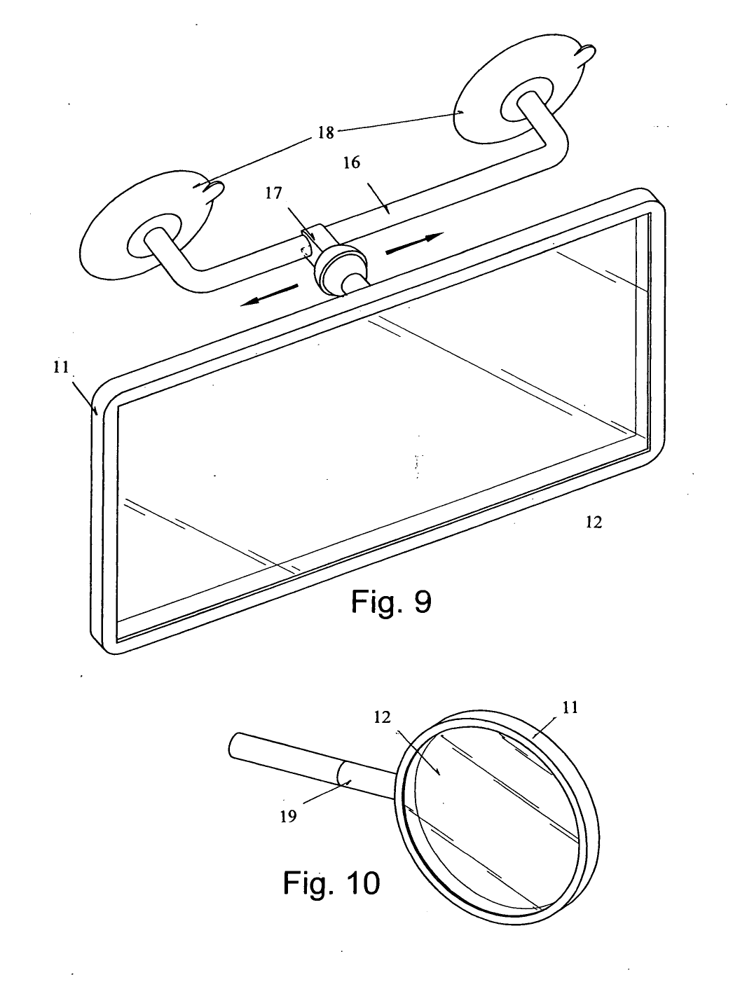

FIG. 9 is a perspective view of the total present invention assembly in yet another example of the versatility factor relating to the total invention assembly's possible construction and deployment type. The view shows the lens holding frame 11 with lens or lenses 12 contained with a ball and socket joint contained on a body section 17 capable of sliding on a horizontal bar 16 for even more horizontal adjustment capability for the driver. The driver simply has to take one hand and push the holding frame 11 the direction the driver needs to capture a distant road sign in the view frame of the lens or lenses 12. The slidable body section 17 encompasses the horizontal bar 16 in a frictional fashion and will hold the desired position slid to by the driver. Also, the view shows another means of attachment 18 type—a suction cup on both end point sides of the horizontal bar 16. The means of attachment 18 would work as means to attach unto the inside face of the driver's overhead sun visor, an upper surface area of the cockpit dashboard, and even the interior surface of the windshield itself, effectively and efficiently covering any viewpoint area the driver deemed as most important for the lens or lenses enhancement capability.

FIG. 10 is a perspective view of a lens holding structure frame 11 with a tangential arm segment 19 capable of being handheld by the driver for viewing through. A holding structure for the arm segment 19 to frictionably fit into along with the various means of attachment shown in the former drawing figures could be designed but is not shown. The arm segment 19 would allow for the driver to quickly remove from its holding frame and allow for a moving hand gripping the arm segment 19 to move the lens or lenses holding frame 11 to the desired viewing point anywhere on the windshield. Exactly stating, the lens or lenses holding frame 11 converts into a handheld very quickly by pulling from a designed holding structure—not shown—holding the arm segment 19.

The descriptive and operative embodiments shown in the drawing figures should not be construed as the only embodiments the present total invention assembly could be as an incorporation. The examples of embodiments disclosed are designed for retrofitting current motor vehicles in use on the highways. Once the lens or lenses component of the present invention assembly is effectively developed, the lens or lenses component can be built into overhead sun visors, rearview mirrors and even windshields on new motor vehicles.

I claim:

1. A lens assembly for a motor vehicle providing enhanced visibility for long distance viewing of objects by a driver of the said motor vehicle, comprising; a transparent lens for viewing through by the said driver, a holding structure for the said transparent lens; means to attach the said holding structure containing the said lens unto a specified structure in the said driver area space deemed as satisfactory for viewing through by the said driver of the said motor vehicle.

2. The lens assembly of claim 1 wherein multiple transparent lenses for viewing through are contained in the said holding structure having the said means to attach unto the said specified structure in the said motor vehicle.

3. The transparent lens component of claim 1 is of a type whereby providing clarification to the said driver for viewing the said long distant objects through the said transparent lens.

4. The multiple transparent lenses component of claim 2 are of a type when arranged in the said holding structure therein providing clarification to the said driver for viewing the said long distant objects through the said multiple lens arrangement.

5. The lens holding structure containing lens of claim 1 is of a type having capability to be handheld by the said driver for viewing deployment at any point on a transparent windshield in the said motor vehicle.

6. The lens holding structure containing the said multiple lenses of claim 2 is of a type having capability to be handheld by the said driver for viewing deployment at any point on a transparent windshield in the said motor vehicle.
